(19) United States
(12) Patent Application Publication
(10) Pub. No.: US 2023/0392360 A1
(43) Pub. Date: Dec. 7, 2023

(54) AN IMPROVED DUCKBILL TYPE VALVE

(71) Applicant: Lake Products Limited, Auckland (NZ)

(72) Inventors: Andrew Leo HAYNES, Auckland (NZ); Gabriel loan GIURGIU, Auckland (NZ); Michael John SUMNER, Auckland (NZ)

(73) Assignee: Lake Products Limited, Auckland (NZ)

(21) Appl. No.: 18/032,727

(22) PCT Filed: Oct. 21, 2021
(86) PCT No.: PCT/IB2021/059744

§ 371 Date: Apr. 19, 2023

(30) Foreign Application Priority Data
Oct. 21, 2020 (NZ) 769214

(51) Int. Cl. E03C 1/298; F16K 15/14

(52) U.S. Cl. CPC E03C 1/298; F16K 15/147

(57) ABSTRACT

This invention relates to a valve, in particular valves providing for a non-return valving capability. The valve of this invention comprises valve lips, at least one of which is flexible and resiliently biased towards another valve lip in a closed condition of the valve in which fluid flow through the valve is inhibited, and is flexibly moveable apart to an open condition of the valve in which fluid flow through the valve is enabled, and which comprises a resiliently deformable opposite fluid entry end of the valve which is resiliently deformable from a first shape to a second shape to fit the valve to a conduit end, wherein deformation of the fluid entry end of the valve to said second shape increases bias of the at least one flexible valve lip towards another valve lip for contact of respective valve lips in the closed condition of the valve.

### FIELD OF INVENTION

The invention relates to an improved valve, such as a duckbill valve or non-return valve.

### BACKGROUND

A duckbill valve comprises resiliently flexible flaps joined along lengthwise sides, or lips, approximately in the shape of a duckbill, which allow forward flow of fluid and prevent back flow. The valve lips are biased to contact one another under no forward flow fluid pressure, and thereby close the valve to back flow. When under forward flow fluid pressure or sufficient forward flow fluid pressure the flexible valve lips are forced apart, to open the valve.

At an opposite entry end the valve is designed to be installed over the end of a pipe, or fixed about a fluid flow outlet in some other form, or in some cases to be fixed within the internal diameter of a conduit.

Duckbill valves are commonly used in plumbing, marine, and medical applications, for example. They are commonly one-piece and formed from a flexible (typically resiliently flexible) synthetic material or rubber by injection moulding.

### SUMMARY OF INVENTION

An object of the invention is to provide an improved, or at least alternative form of, duckbill valve or a valve suitable for use as a non-return valve.

In accordance with a first aspect, there is provided a valve, such as a duckbill valve, comprising: valve lips at least one of which is flexible and resiliently biased towards the other in a closed condition of the valve in which fluid flow through the valve is inhibited, and is flexibly moveable apart to an open condition of the valve in which fluid flow through the valve is enabled, and which comprises a resiliently deformable opposite fluid entry end of the valve which is resiliently deformable from a first shape to a second shape to fit the valve to a conduit end, wherein deformation of the fluid entry end of the valve to said second shape increases bias of the flexible valve lip towards the other or contact of the valve lips in the closed condition of the valve.

In accordance with a second aspect, there is provided a valve, such as a non-return valve or a duckbill type valve, said valve comprising:
valve lips, at least one of which is flexible and resiliently biased towards another valve lip in a closed condition of the valve in which fluid flow through the valve is inhibited, and is flexibly moveable apart to an open condition of the valve in which fluid flow through the valve is enabled,
and which comprises a resiliently deformable opposite fluid entry end of the valve which is resiliently deformable from a first shape to a second shape to fit the valve to a conduit end,
wherein deformation of the fluid entry end of the valve to said second shape increases bias of the at least one flexible valve lip towards another valve lip for contact of respective valve lips in the closed condition of the valve.

The valve may further comprise opposite or substantially opposing valve lips at least one of which is resiliently biased towards one another in the closed condition of the valve, and the at least one flexible lip is moveable apart from one another lip to the open condition of the valve in which fluid flow through the valve is enabled, and wherein deformation of the fluid entry end of the valve to said second shape increases bias of the at least one flexible valve lip(s) towards another lip or contact of the valve lips in the closed condition of the valve.

There may be a pair of substantially opposing flexible valve lips.

There may be three or more flexible valve lips configured to be biased towards each other for contact of these respective valve lips to bring the valve into a closed condition, and wherein said three or more flexible valve lips a moveable apart from each other into an open condition of the valve.

The first shape may be different to the second shape.

The first shape may be non-circular and said second shape may be circular.

The first shape may be substantially oval and wherein the second shape may be the shape of a conduit or outlet or spigot end of a fitting upon which the fluid entry end of the valve is to be fitted (i.e., the fluid entry end of the valve assumes or takes-up the shape of the fitting to which it is to be fitted upon).

The valve wherein at least when the fluid entry end of the valve is deformed to said second shape, and the valve is in a closed condition, the flexible valve lips may extend at an angle, such as an off-set angle, relative to a longitudinal central axis through the valve.

The flexible valve lips may be relatively thin-walled, joined at longitudinal edges, and are longer in a fluid flow direction length of the valve than they are wide across said length of the valve, and wherein deformation of the fluid entry end of the valve to define the second shape of the fluid entry aperture increases bias of the flexible valve lips towards one another across a width of the flexible valve lips and along at least part of a length of the flexible valve lips, in the closed condition of the valve.

There may be a tapered intermediate portion between the fluid entry end and the flexible valve lips.

The intermediate portion may comprise an internal cross-section area which reduces between the fluid entry end and the flexible valve lips.

The valve may further comprise opposing enlarged side parts, at or part way along opposite longitudinal sides of the valve.

The opposing enlarged side parts may be less flexible than the flexible valve lips.

The opposing enlarged side parts may be relatively closer to the fluid entry end of the valve than to a fluid exit end of the valve.

The opposing enlarged side parts may be at opposite joins or joining portions on opposite longitudinal sides of the valve.

The opposing enlarged side parts may be enlarged (seam) parts of the opposite joins or joining portions on opposite longitudinal sides of the valve.

The valve may further comprise a tapered intermediate portion between the fluid entry end and the flexible valve lips and wherein opposing enlarged side parts are at opposite sides of the tapered intermediate portion.

The entry end of the valve may comprise a flange extending around the fluid entry aperture to fit over or into an end of a conduit, and the fluid entry end of the valve can be deformed from the first shape to the second shape to fit over or into the end of the conduit and to define the fluid entry aperture.

The entry end of the valve may comprise a flange around the fluid entry aperture to fit over or into a circular end of a conduit when the fluid entry end of the valve is deformed to define a circular fluid entry aperture.

The valve may be formed as a one-piece or unitary body.

At the fluid entry end, there may be a non-integral rigid non-circular or circular ring.

The valve may further comprise a housing about the valve, the housing comprising of an outlet end adapted to couple to a downstream conduit and deliver fluid flow from the valve when in the open condition into the downstream conduit.

The valve may comprise, at the fluid entry end, a coupling ring, and an inlet end of the housing is adapted to couple to said coupling ring of the valve.

The valve coupling ring may comprise of a threaded interior and a threaded exterior, and the inlet end of the housing may have a threaded interior for coupling to the threaded exterior of the coupling ring.

At least one of the valve lips may comprise of one or more strengthening elements or members.

The one or more strengthening elements or members may comprise one or more of: a relatively thicker wall or relatively thicker wall portion(s) than another valve lip or a substantially opposing valve lip(s), one or more ribs extending about or along at least one valve lip or each valve lip or both of a pair of opposing valve lips, one or more other surface features which may be used to characterise or impart a different stretch or deformation characteristic to at least one valve lip or each valve lip or both of a pair of opposing valve lips.

The one or more ribs may extend in a longitudinal length direction of at least one valve lip or each valve lip, or each of a pair of opposing valve lips, or extend radially about at least one valve lip or each valve lip or each of a pair of opposing valve lips, or may extend in plurality of directions along at least one valve lip or each valve lip or each of a pair of opposing valve lips.

The valve may comprise of a plurality of valve lips brought into contact with each other by an induced force or tension applied to one or more or all of said plurality of valve lips with a positive contact or sealing force with each other, said positive contact or sealing force adjustable depending upon a deformation of the fluid entry end of the valve.

In the open condition with the valve lips apart, a fluid flow through the valve can be enabled to flow in a direction from the fluid entry end of the valve (being the fluid received into the fluid entry end of the valve) to a fluid exit end from the valve via the valve lips.

The valve in the closed condition operates as a non-return valve.

The valve lips can provide for a self-closure and a sealing force of the valve lips, independent of a downstream backpressure upon the valve lips.

In a third aspect, there is provided a valve fitting comprising the valve according to either of the first or second aspects.

In a fourth aspect, there is provided a waste valve plumbing fitting comprising the valve according to either of the first or second aspects.

In a fifth aspect, there is provided a waste valve and trap plumbing fitting comprising the valve according to either of the first or second aspects.

In a sixth aspect, there is provided a fitting according to any one of the third, fourth or fifth aspects, further comprising:

a housing about the valve comprising a fluid flow inlet to the housing and a fluid flow outlet from the housing.

The housing may comprise two parts which are adjustable relative to one another to enable length adjustment of the housing.

The valve may be carried by a part which inserts into the fluid flow inlet to the housing.

The valve may for example be a non-return valve and may be of the form of a duckbill type valve fitting, a waste valve plumbing fitting comprising such a valve, or a waste valve and trap plumbing fitting comprising such a valve. The valve product may alternatively be a marine or medical valve for example.

The valve as described herein may find application as a replacement for any non-return valve.

The valve as described herein is configured such that, in-use, the valve provides for its own positive closing or closure force. Consequently, the valve as configured in the invention described herein avoids the need to rely upon a back pressure of fluid upon the valve lips to keep the valve lips in a closed condition (as is typically required of known duckbill valves or also as non-return valves).

In this specification “closed” and “open” are used relatively, and “closed” also includes to inhibit but still allow some fluid flow, relative to fluid flow when the valve is open. In this specification, “fluid” has its normal meaning of reference to either liquids or gases.

Also, in this specification the term “comprising” means “consisting at least in part of”. When interpreting a statement in this specification and claims that includes “comprising”, features other than that or those prefaced by the term may also be present. Related terms such as “comprise” and “comprises” are to be interpreted similarly.

### BRIEF DESCRIPTION OF THE FIGURES

The invention is further described with reference to the accompanying figures which show embodiments of a valve of the invention, and of waste valve fittings and waste valve and trap fittings incorporating a non-return valve, such as a duckbill valve, by way of example and without intending to be limiting. In the figures:

FIG. 1 is a perspective view from one end of an embodiment of the valve, uninstalled and in a relaxed condition—but with the opposing valve lips shown slightly apart for the purposes of illustration.

FIG. 2 is a perspective view from an opposite end of valve of FIG. 1, in a relaxed condition.

FIG. 3 is a side view of the valve of FIGS. 1 and 2, in the direction of arrow A in FIG. 1, in a relaxed condition—but with the opposing valve lips shown slightly apart for the purposes of illustration.

FIG. 4 is another side view of the valve, in the direction of arrow B in FIG. 1, in a relaxed condition—but with the opposing valve lips shown slightly apart for the purposes of illustration.

FIG. 5 is a view of the valve from the entry end, in the direction of arrow C in FIG. 1, in a relaxed condition—but with the opposing lips shown together (in a closed condition).

FIG. 6 is a view of the valve from the exit end, in the direction of arrow D in FIG. 1, in a relaxed condition—but with the opposing lips shown together (in a closed condition).

FIG. 7 is a view of the valve from the entry end similar to FIG. 5 but with the valve (and the opposing lips) in an open condition.

FIG. 8 is a perspective view of an embodiment of the valve attached (i.e. in the fitted condition) to a circular ring (the valve and ring are a part of the waste valve fitting of FIGS. 12 to 15), with the valve in a closed condition and when the valve lips are under a tension due to the fluid entry end having been fitted to a spigot or outlet end of a conduit, the fluid entry end consequently changed from a first shape (when in a relaxed condition and not under a tension load) to a second shape (when under a tension load).

FIG. 9 is a perspective view of the valve and ring of FIG. 8, with the valve (and the opposing lips) in an open condition under forward fluid flow (fluid flow not shown).

FIG. 10 is a longitudinal cross-section view of the valve of FIGS. 1 to 7, when fitted to the end of a pipe and in a closed condition—illustrating the valve in the closed condition with the valve lips in a ‘kicked off” or ‘offset’ position from a notional longitudinal centreline (such as illustrated by the dot-dash style line in FIG. 11).

FIG. 11 is a longitudinal cross-section view of the valve of FIGS. 1 to 7, shown in the fitted condition to the end of a pipe and in an open condition under forward fluid flow (fluid flow not shown).

FIG. 12 shows an embodiment of a ‘straight-through’ waste valve fitting comprising a valve of the invention, fitted to the outlet from a sink, with the valve shown in phantom outline and closed.

FIG. 13 is a view similar to FIG. 12 of the ‘straight-through’ waste valve fitting with the valve open with an indicative flow of fluid shown flowing out of the valve.

FIG. 14 is an exploded view of the ‘straight-through’ waste valve fitting of FIGS. 12 and 13 (note the fluid entry end of the valve is shown in a shape to which the fluid entry end has been modified from the first shape to a second shape in a fitted condition, when fitted to a waste valve fitting (i.e., FIG. 14 does not show the fluid entry end of the valve in a ‘relaxed’ condition).

FIG. 15 is a cross-section view of the ‘straight-through’ waste valve fitting (non-exploded) along line E-E of FIG. 14.

FIG. 16 is a cross-section view of a ‘straight-through’ waste valve fitting similar to that of FIGS. 12 to 15 but designed for coupling to a pre-existing waste fitting already installed to a sink outlet.

FIG. 17 is a cross-section view similar to that of FIGS. 15 and 16, of a ‘straight-through’ valve fitting similar to that of FIGS. 12 to 15, but designed for coupling to a pipe end using a compression ring,

FIG. 18 is an exploded view of an embodiment of an ‘extendable bend’ waste trap and valve fitting comprising a valve of the invention, for fitting to the outlet from a sink (note the fluid entry end of the valve is shown in a shape to which the fluid entry end has been modified from a first shape to a second shape (i.e. into the fitted condition) for fitting (i.e. FIG. 14 does not shows the fluid entry end of the valve in a ‘relaxed’ condition).

FIG. 19 is a cross-section view of the ‘extendable bend’ waste trap and valve fitting of FIG. 18 along line F-F of FIG. 18, but non-exploded and with the ‘extendable” plumbing fitting in a shortest or shortened configuration.

FIG. 20 is a cross-section view of the ‘extendable bend’ waste trap and valve fitting of FIGS. 18 and 19 along line F-F of FIG. 18 but non-exploded and with the fitting in its longest configuration or elongated or extended configuration.

FIG. 21 shows an embodiment of a ‘horizontal’ valve fitting comprising a valve of the invention.

FIG. 22 is a cross-section view of the ‘horizontal’ valve fitting of FIG. 21 along line G-G of FIG. 21.

FIG. 23 shows an embodiment of a waste box comprising at its outlet a valve fitting comprising a valve of the invention.

FIG. 24 shows an embodiment of a valve similar to that of FIGS. 1-23, but where the valve lips are arranged or positioned to be off-set from a longitudinal central axis which otherwise would extend through the valve body from the aperture end (2a) to an exit end of the valve lips (3), such an off-set indicated by item L. FIG. 24 is a top perspective view looking down upon the fluid entry end of the valve.

FIG. 25 is the embodiment of FIG. 24, shown from a bottom perspective view looking upward at a terminal end of the valve lips (at a fluid exit point) and to underside of the flange region at the fluid entry end.

FIG. 26 is a top view looking down into the valve, but at a slight perspective angle to illustrate the off-set nature of the valve lips relative to the aperture of the fluid entry end of the valve.

FIG. 27 is a bottom view looking upwardly at the terminal (fluid exit) end of the valve lips, illustrating how the valve lips may be in a relaxed (unfitted) condition.

FIG. 28 is a side view of the valve of FIGS. 24-27, further illustrating the off-set nature of the valve lips.

FIG. 29 is a top view looking down into the aperture end of the valve, again showing the off-set nature of the valve lips.

FIG. 30 is a cross-sectional view of the valve of FIGS. 24-29, further illustrating the offset.

FIG. 31 is a top perspective view of a further embodiment, illustrating a valve with more than two valve lips (shown are three sets or three pairs of substantially opposing valve lips).

FIG. 32 is a bottom perspective view of the valve of FIG. 31.

FIG. 33 is a top down (plan) view of the valve of FIG. 31.

FIG. 34 is a side view of the valve of FIG. 33.

FIG. 35 is a bottom-up view of the valve of FIG. 31 (i.e., opposite view of FIG. 33).

FIG. 36a is illustrates an assembly or exploded view of an assembly of a valve of FIG. 31 to be fitted to a fitting or conduit P, note the shape of the fitting or conduit P is a different shape to the first shape of the valve when in a relaxed condition.

FIG. 36b is the assembled or fitted condition of the valve of FIG. 31 onto the fitting or conduit P, note the entry end of the valve has taken up the shape of the fitting or conduit P, thereby changing from a first shape to a second shape.

FIGS. 37a and 37b are alternative arrangements compared with FIGS. 36a and 36b, where the valve is fitted to the fitting or conduit P in a different orientation, to provide for an induced stretch and/or deformation of the entry end of the valve different to the stretch and/or deformation which would be experienced by the entry end of the valve as shown in FIGS. 36a and 36b.

### DETAILED DESCRIPTION OF EMBODIMENTS

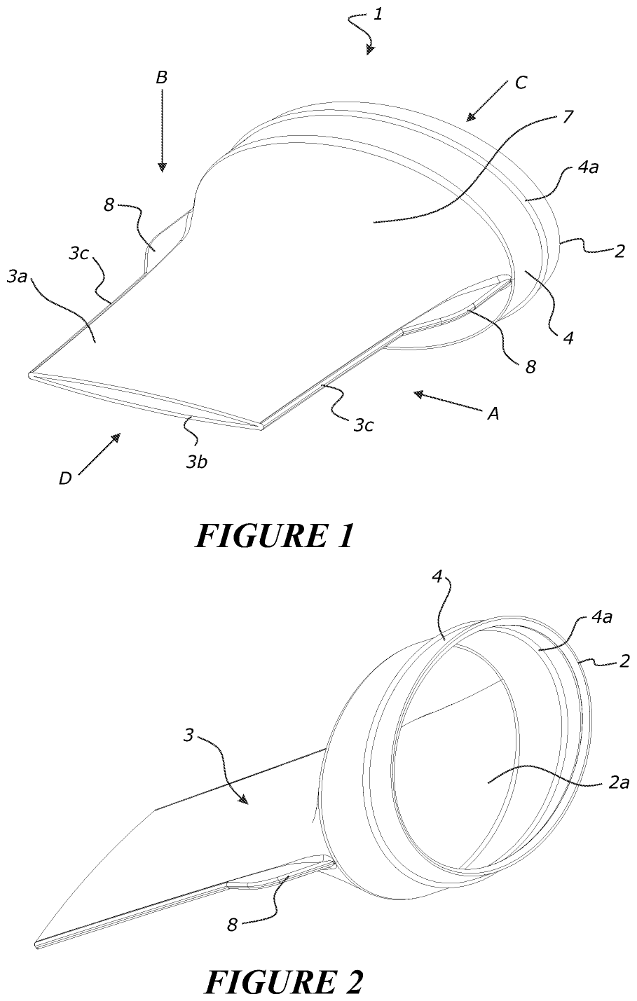

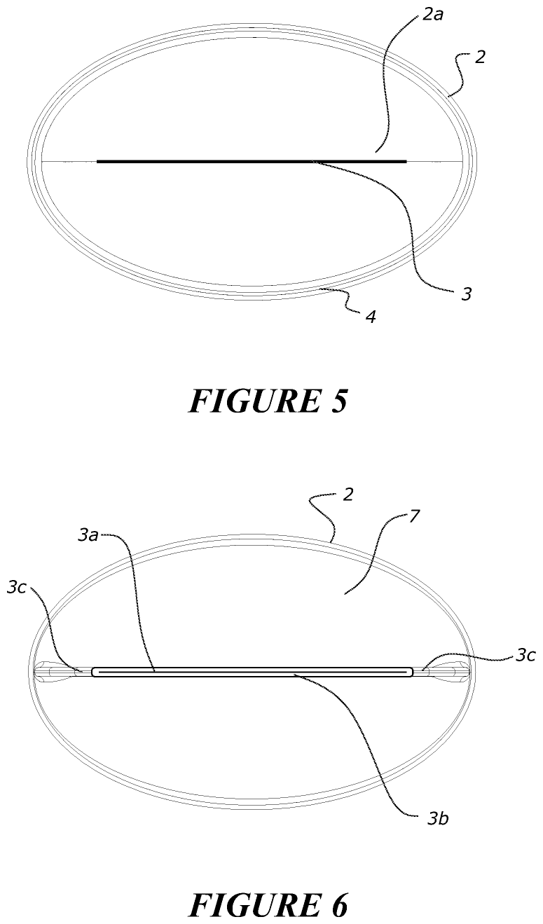

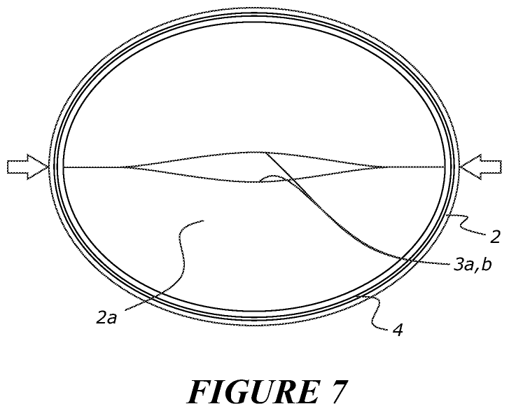

The embodiment of a valve, such as a non-return valve or a valve 1 of the invention, shown in FIGS. 1 to 7, is advantageously a one-piece, or unitary, member, and may be moulded by compression or injection moulding.

The compression or injection moulding material may be, for example, a synthetic material such as an elastomeric synthetic material e.g., a silicone material, or rubber, or flexible polymer type material. The valve 1 comprises of an open entry end 2.

The open entry end 2 is designed or configured to be stretched and/or deformed, from a relaxed condition or a first shape towards a fitted condition or a second shape (or a subsequent shape.

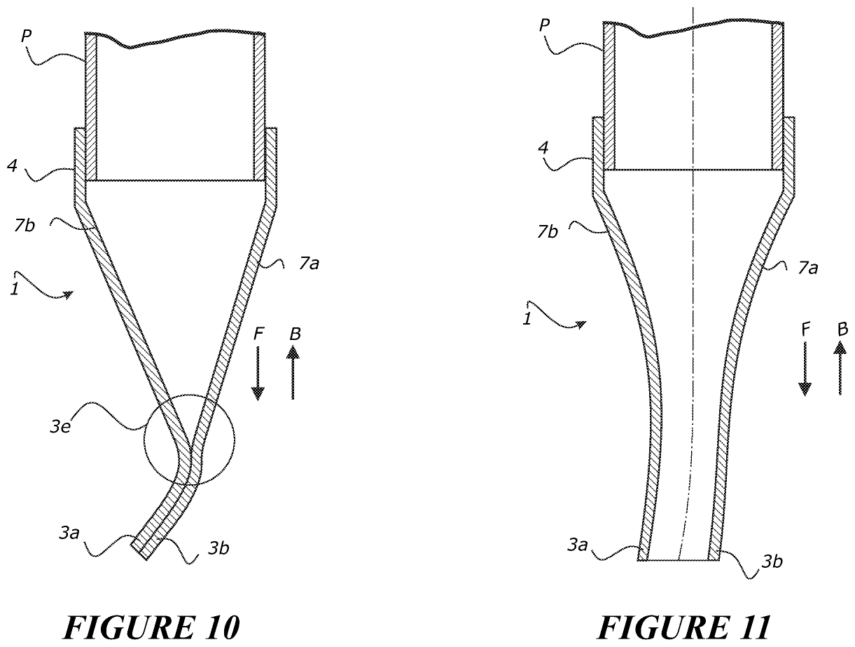

The open entry end 2 may be clamped or otherwise fitted over the end of a pipe or other conduit or fluid outlet—for example, as shown in FIG. 10 and 11. The valve comprises of valve lips 3 comprising flexible flaps 3a and 3b joined along lengthwise sides and un-joined at their ends (i.e., at a terminal end of the lips 3, being an exit end of the valve 1), which depending on the number of valve lips 3 may approximate the shape of a duckbill.

Where a plurality of valve lips 3 are provided by the valve and are brought together when the open entry end is stretch and/or deformed from the first shape to the second shape, the valve lips may less approximate a duckbill, but still provide similar functionality with a plurality of valve lips coming together when in their closed condition and being moved apart from each other by the positive flow of fluid through the valve which parts the valve lips 3.

The valve lips 3a and 3b are opposed or substantially opposing of each other, relatively thin walled, and meet along or are joined at longitudinal sides or edges 3c. Typically, the flexible valve lips 3 are longer (in the fluid flow direction or length of the valve) than they are wider (across the valve)—although it will be appreciated this may not necessarily be a geometric limitation, as the shape of the valve (or relative proportions of length and width) can be varied depending on, for example, materiality characteristics or other structural detailing which can be provided as part of the valve.

In some embodiments, for example, at least one of the valve lips may comprise of one or more strengthening elements or members. Such elements of members may take the form of one or more of: a relatively thicker wall(s) or relatively thicker wall portion(s) than another valve lip or a substantially opposing valve lip(s), one or more ribs extending about or along a valve lip or both of a pair of opposing valve lips, one or more other surface features which may be used to characterise or impart a different stretch or deformation characteristic to a valve wall or each of a pair of opposing valve walls. Where ribs may be provided, such ribs may comprise of discontinuities (i.e., such a rib or ribs may not be continuous along an entire length or width or a valve lip).

Optionally, any such discontinuity or ‘gap’ may be provided to facilitate a preferential bending or preferential area or region of less rigidity or greater flexibility compared with other areas or regions which may have been strengthened or made less flexible (or more rigid) by the inclusion or provision of such ribs.

Similarly, relatively greater valve lip wall thickness may be provided in pre-defined areas or regions to preferentially increase the strengthening of a valve lip area or region, thereby accentuating the relative flexibility of other such areas or regions. In this manner, such elements or members can be provided about or along one or more valve lips to encourage an inducement of a tension about one or more of the valve lips when the open entry end 2 is stretched and/or deformed from the first shape to a second shape or a subsequent shape, thereby imparting an induced force of closure or bringing together of at least one of the valve lip(s) together with the other valve lip(s) to creature a positive valve lip closure force (and a closing of the valve lips 3). A positive flow of fluid through the valve can part the valve lips 3 from their closed condition, but in the absence of a positive flow of fluid through the valve, the valve lips are returned to their closed condition under the influence of a tension applied to at least one of the valve lip(s).

As noted above, the elements or members are provided as control features about one or more valve lips to provide for an intended or preferential control of the shape of the valve and valve lips once the open entry end of the valve is changed from the first shape to a second shape or subsequent shape.

In relation to the first shape, the first shape may be any shape. The first shape will be the shape of an as-moulded entry end 2 of the valve 1. Illustrated in the figures are various forms when the valve 1 is in a relaxed condition, and the entry end 2 is shown in a first shape.

Once the valve 1 is fitted to an outlet or conduit or spigot end of a conduit (for discharging a flow of fluid into the entry end 2 of the valve 1), the entry end 2 is deformed and/or stretched or otherwise modified in shape to accommodate to the shape of the fitting upon which the entry end 2 is to be fitted. In fitting, the entry end 2 takes up the shape of the fitting, consequently the entry end 2 of the valve is stretched and/or deformed into a second shape.

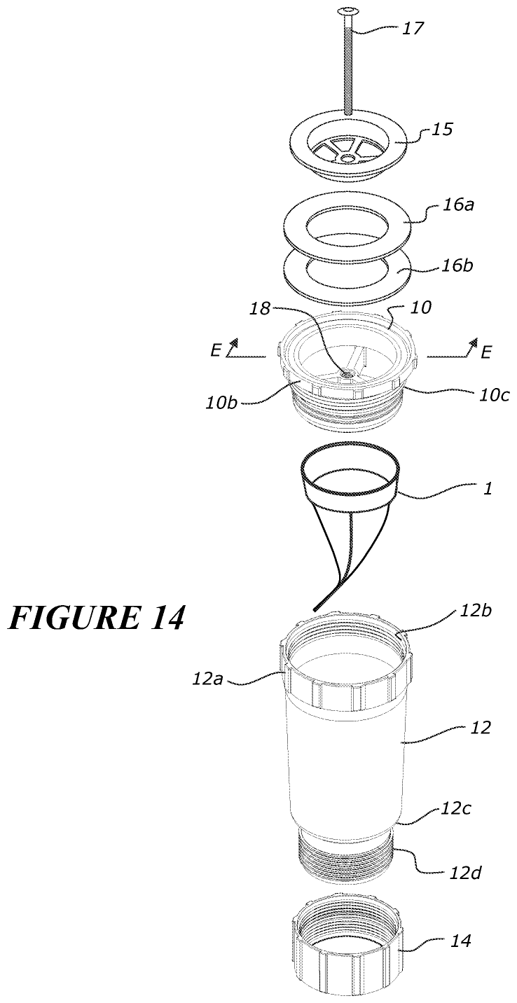

The first shape can be a different shape to the second shape. For example, in one embodiment as illustrated by FIGS. 1-22, the entry end 2 in its first shape configuration may be of a non-circular shape (being an oval); while the second shape configuration may be of a circular shape.

It will be appreciated that different first and second shape configurations can be provided.

Furthermore, the first shape may be the same as the second shape, but where the first shape of the entry end 2 of the valve 1 may be fitted to the second shape in a different orientation—for example, the entry end 2 may be rotated through an angle and then fitted/installed upon the fitting having the same shape. In this manner, a stretch and/or deformation of the entry end 2 of the valve 1 from the first shape is still achieved. For the sake of clarity, the purpose of the stretch and/or deformation of at least the entry end 2 of the valve 1, is to impart or induce a tension into at least one (or more) of the valve lips 3 to provide a bias of at least one of the valve lips 3 toward the other of the valve lips provided by the valve, and in doing so, providing a closure force of the valve lips together.

The tension can be achieved by imparting a disparity in tension about the entry end 2, which is in turn imparted to at least one or more of the valve lips 3. That is, the perimeter of the entry end 2, when changed by a stretch or deformation from its first shape or first shape orientation to a second shape or a second shape orientation, is modified to experience a non-uniform stretch and/or deformation. For example, the stretch or deformation or tension experienced about the perimeter of the entry end 2 may be non-uniform when modified from the first shape or first shape configuration to take up the second shape or second shape configuration.

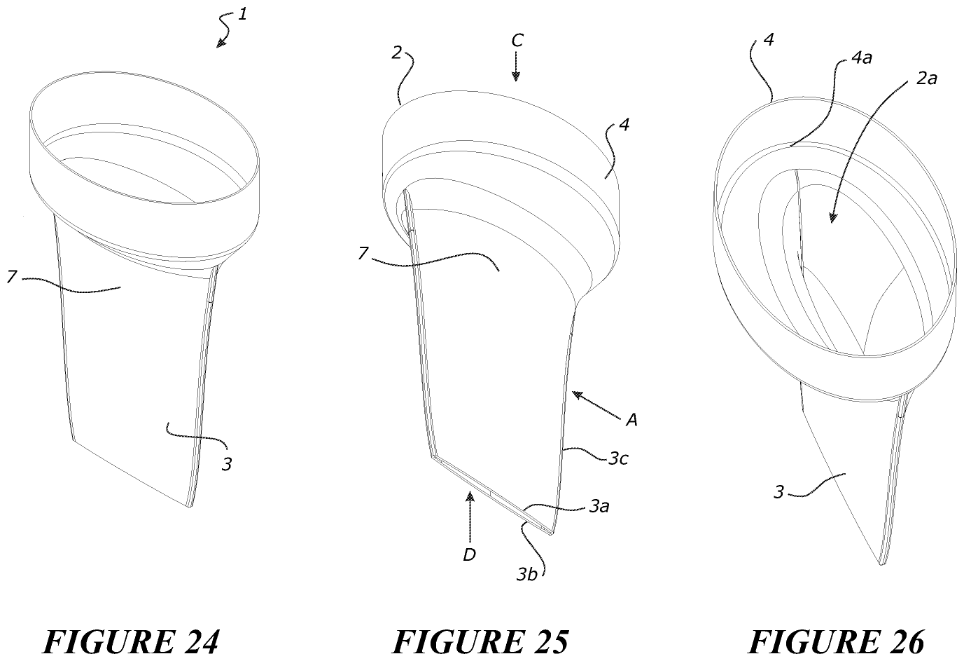

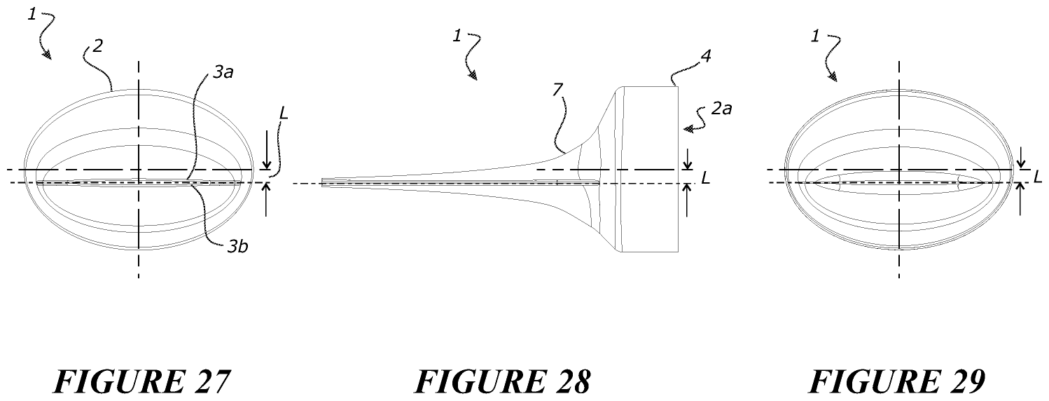

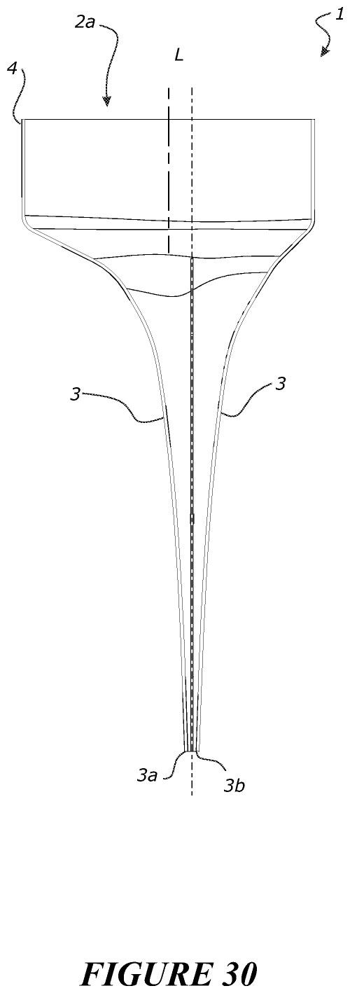

In various embodiments of the valve, the positioning or location of the lips 3 relative to the entry end 2 may be arranged to be non-symmetrical with the opening of the entry end. For example, as shown by the embodiment of FIGS. 24-30, the valve lips 3 are positioned to be off-set relative to the centre of the opening of the entry end 2. In this manner, a differential in tension applied to the valve lips 3 when the entry end 2 is stretched and/or deformed from its first shape to its second shape, thereby encouraging a bias tension induced in one of the valve lips more than another.

In various configurations, a predetermined amount of stretch or deformation can be applied to the first shape in reaching the second shape to apply a desired valve lip closure force. As such, the valve can be engineered to achieve a desired or certain percentage of stretch when stretch and/or deformed from the first shape to the second shape, depending on a desired induced closure force of respective valve lips or a force for parting or opening of the valve lips to allow for the passage of a flow of fluid.

It will be appreciated different forces of closure or opening of valve lip may be desirable for different applications. For example, where low flows or low(er) pressure valve operation is desired, a relatively smaller closure or opening force would be wanted. Conversely, where stronger fluid flows are put through the valve, or where a stronger closure force or where the force to part the valve lips may need to be greater, a greater closure force of the valve lips would be employed. Lower closure/opening forces would provide for a valve with greater sensitivity.

The force needed to open the valve lips can be adjusted depending on the closure force induced, and consequently can be programmed into a valve depending on the intended end-use or application of such a valve.

Where the closure force is relatively low, this will provide for a relatively low or light seal of respective valve lips against each other, and the required opening pressure is consequently also relatively low. In some applications, a relatively heavier seal may be desired to provide for a higher resistance to opening or parting of the valve lips, so would typically be more suitable for higher pressure fluid line application. It will be appreciated the valve lip sealing pressure can be variably adjusted based upon an adjustment of the relative stretch applied at the entry end 2 and induced into the valve lips.

The valve comprises an integral flange 4 around the fluid entry aperture 2a, to fit over (for example) a circular end of a pipe end or conduit or other fitting. Fitting the valve to the circular pipe end deforms the fluid entry end 2 including flange 4, from a relaxed condition or a first shape, to define a circular fluid entry aperture or a second or subsequent shape. This also stretches and/or deforms slightly, or at least imposes different stresses in, other parts of the valve, or valve body, which moves or biases together (or increases the bias together of) the flexible valve lips 3 as further described below.

In absence of forward fluid flow, when the open end of the valve, or the integral flange, is in the second or subsequent shape (from the first shape) the valve is biased into a normally closed condition (with the valve lips 3a, 3b induced into their closed condition or position).

In the embodiment illustrated by FIGS. 1 to 6, the valve is shown unfitted and in its relaxed condition—as such, the valve lips 3a, 3b are not additionally induced to be in a closed condition (although they may be in a closed condition or state or configuration). That is, there is no positive closure force between the respective lips 3.

In the embodiment shown, the flange 4 incorporates an integrally moulded O-ring 4a, on both the external and internal surfaces of the flange 4. The O-ring 4a, assists in forming a fluid tight sealing between the valve and pipe end. Alternatively, the O-ring is a mounting ring which screws or fits over the flange 4 in-use.

Alternatively, such an integrally moulded O-ring may be provided only on the external or only on the internal surface of the I mounting flange. Alternatively, the flange 4 may have a groove for receiving a separate O-ring, on the external and/or on the internal surfaces. Alternatively, no O-ring may be required.

At least in the embodiment shown the valve may also comprise a tapered intermediate portion 7 between the fluid entry end 2 and the flexible valve lips 3. This intermediate portion 7 has an internal cross-section area which reduces between the fluid entry end 2 and the flexible valve lips 3. Fitting of the valve over the circular pipe end deforms the fluid entry end 2 from a first shape to a second or subsequent shape, such as defining a circular fluid entry aperture as described in one example.

As a result of altering the shape of the fluid entry end 2 of the valve 1 from the first shape to a second or subsequent shape during the fitting of the valve, this change in turn imparts a deformation to the tapered intermediate portion 7, and in-turn imparts a deformation/change to the shape of the flexible valve lips 3, all away from the valve shape when the valve is not fitted to a circular pipe end (i.e. the ‘relaxed’ condition or state or configuration and first shape), so that in the absence of a forward fluid flow the flexible valve lips 3 are induced or biased (or positively forced) into a normally closed condition or state or configuration.

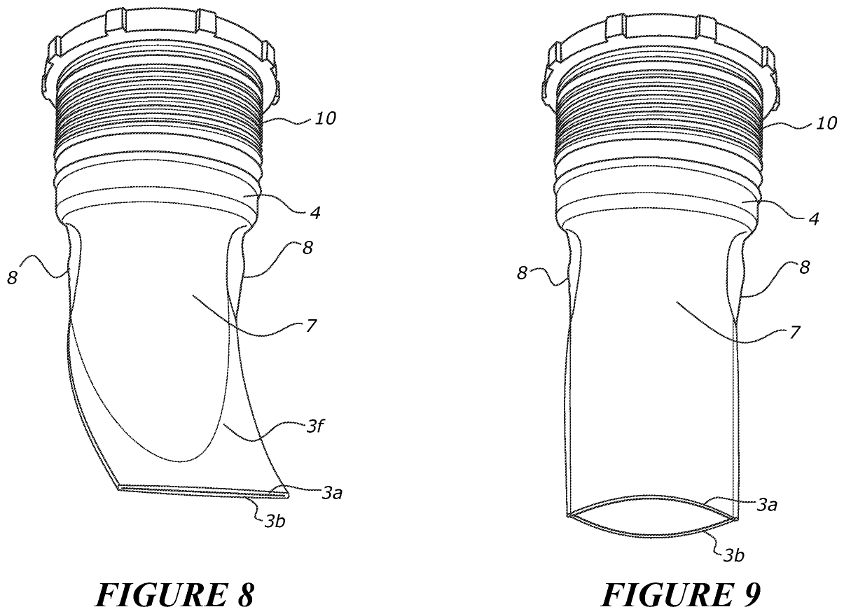

When the valve is for example fitted to a pipe end or other conduit or fluid outlet, and under no forward flow fluid pressure (e.g., are at atmospheric pressure) or under only very low forward flow fluid pressure through the valve, the flexible valve lips 3 are preferentially biased or induced towards each other to be normally lightly positively closed, as shown in FIG. 10, and also FIG. 8 for that embodiment. This closes the valve to minimise or prevent back flow. In FIG. 10, a pipe end is indicated at P with arrow B indicating the back flow direction.

FIG. 10 also illustrates the valve lips biased or induced together to their normally (or positively) closed condition or state or configuration when the valve is fitted (and the valve entry end is changed from a first shape to a second or subsequent shape). FIG. 8 further illustrates such an embodiment.

With such a normally (or positively) closed condition or state or configuration, the valve 1 operates as a (positively or normally closed) non-return valve as the valve does not rely upon a backpressure against the valve lips to maintain the valve lips inn a closed condition in the absence of a forward fluid flow.

When the valve is fitted to a pipe end or other conduit or fluid outlet and is in its fitted condition, and under positive forward flow fluid pressure through the valve, or forward flow pressure above a threshold, the flexible valve lips 3 are forced apart (by the flow of fluid). When the flexible valve lips 3 open valve lips allow forward flow of fluid, as shown in FIG. 11, and also FIG. 9 for that embodiment. In FIG. 11 a pipe end is indicated at P and arrow F indicates the forward flow direction.

When the valve is not fitted to a pipe end or other conduit or fluid outlet, the fluid entry end of the valve is non-circular or a first shape (this is also referred to as the ‘relaxed’ condition or state or configuration). The fluid entry aperture 2a of a first shape and may be non-circular, for example may be oval or elliptical, as shown in FIGS. 1 to 6.

The valve has a shape memory towards this first shape and can be a non-circular shape when not fitted to a circular pipe end. The valve, or at least the lips 3, and fluid entry end 2, is/are resiliently deformable. To fit the valve to the pipe end the fluid entry end 2 is deformed, to define instead a second shape and can changed or transformed to be a circular fluid entry aperture shape, as it is fitted over (or into) the pipe end (or another circular conduit or fluid outlet).

This deformation of the valve as it is fitted, when the fluid entry aperture 2a is changed from the first shape when in the relaxed condition, to the second or subsequent shape when in the fitted condition, for example to a round conduit or pipe, is induced to become circular, can preferentially increases bias or inducement of the flexible valve lips 3 towards one another, when the valve is in place and fitted on the pipe end and is closed.

Alternatively, as the valve is fitted, the entry end 2, or entry end 2 and intermediate portion 7, deforms when the fluid entry aperture 2a changes from the first shape (when the valve is in the relaxed condition) to the second shape or subsequent shape (when the valve is in the fitted condition) such as changing from a substantially oval shape as the first shape to become the second shape or a subsequent shape, such as a circular shape, and induced or increases bias of the flexible valve lips 3 towards one another, when the valve is in place on the pipe end.

The increased bias of the flexible valve lips 3 towards one another, when the valve is fitted to the pipe end, may occur particularly in the portion of lips 3 closer to the entry end of the valve than to the terminal end of the lips. This is circled at 3e in FIG. 10 and indicated at the (curved) line 3f in FIG. 8. In this part of the length of the lips 3, the lips 3 may be positively (lightly) forced against one another when the valve is fitted to the pipe end. When this occurs, the valve forms a positive seal along or in the region of the line indicated by item 3f. Further along the length of the lips 3 towards their terminal end, the lips may simply touch without positive force against one another, or only nearly touch but with a slight separation. Preferably this occurs without a reduction in the cross-section area or ‘necking’ of the intermediate portion 7.

Also, in region 3e/line 3f where the lips may be positively (lightly) forced against one another and/or touch, this may occur over most but not necessarily all of the width across the lips in this region. In particular, the lips may be slightly separated, or not positively forced together, in area 3e, adjacent the lip edges 3c.

The deformation of the valve as it is fitted, or at least of the entry end 2, or entry end 2 and intermediate portion 7, can increase the inducement or bias of the flexible valve lips 3 towards one another. This may be also considered as increasing tension in the lips 3.

The deformation of the valve as it is fitted, as well as involving deformation (change from one shape to another), may also involve some degree of stretch of the valve material. The valve as it is fitted and its shape is deformed or deformed and stretched in one axis of the valve (or parts of the valve), may create, or increase closing tension in a different axis in parts of the valve. For example, deformation of the entry end 2, or entry end 2 and intermediate portion 7, of the valve in an axis parallel to the opening between the lips 3, increases tension of the lips in a perpendicular axis towards one another.

As stated, when the valve is not fitted to a pipe end and the fluid entry aperture 2a is in the relaxed condition or first shape (such as a non-circular shape, examples of which may be oval or elliptical, as shown, in at least some embodiments) the lips 3 may not be closed together as there is no force or bias induced to encourage the respective valve lips to be brought together.

The opening between the lips 3 may also define an oval or elliptical opening. Then when the valve is fitted to a pipe end, and the deformation of the entry end 2, or entry end 2 and intermediate portion 7, from a first shape to take up a second shape or a subsequent shape, for example that of a circular pipe end, induced deformation of the fluid entry aperture 2a into a circular shape as described above. This deformation also tends to encourage the biasing or inducement force between the lips 3 to close preferentially together (when there is no fluid flow through the valve).

In some embodiments, such as that shown in all figures, the deformation of the valve, increases bias or inducement force upon the flexible valve lips 3 to encourage the lips towards one another (when the valve is closed).

The strength or force of the bias or inducement can be increased or decreased depending on the relative stretch and/or deformation imparted when the entry end 2 is changed from the first shape to the second shape, with greater stretch and/or deformation typically resulting in relatively greater valve lip closure forces (and therefore greater force needed to part or open the valve lips for the flow of fluid to pass through).

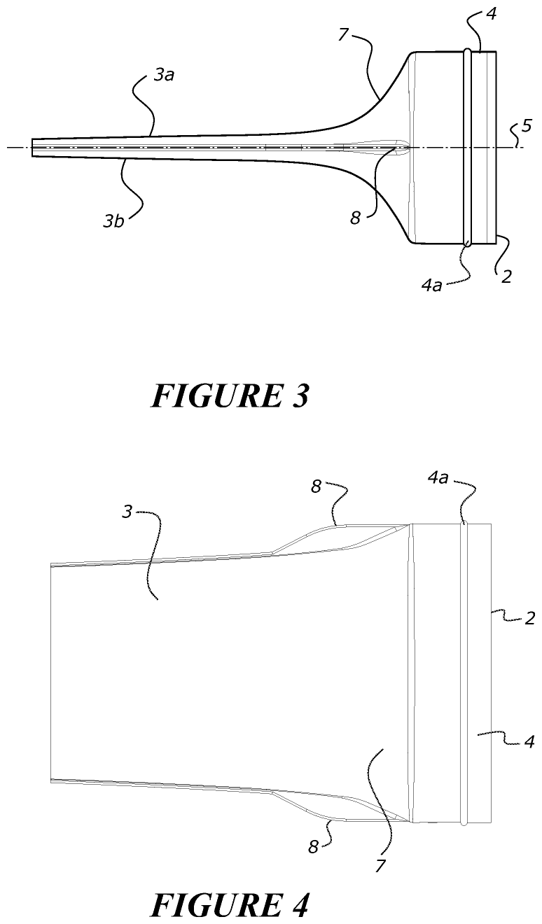

Deformation of the valve from the first shape to the second or subsequent shape also tends to deform, tip, kick, or move the flexible valve lips 3 or at least a terminal portion of the flexible lips, such as that approximately after contact area 3e/line 3f, from or out of alignment with a central longitudinal axis 5 (see FIG. 3) through the valve—see FIGS. 8 and 10. For example, the longitudinal axis of the fluid entry end is then offset relative to a longitudinal axis of a fluid exit end of the valve.

This may increase the force or pressure with which the lips 5 contact one another when the valve is closed. For example, there is an increased force or pressure or closure force at the contact area 3e/line 3f creating a more positive or closure seal when the valve is closed. In this fitted, but valve closed, condition the lips 3 may extend at an angle from about 5 or 10 degrees up to about 30 or 45 degrees, for example, to the longitudinal axis 5 through the valve. As noted previously, the force of closure of the valve lips can be engineered into the valve depending on the intended application and operational characteristics desired for the end-use.

During opening of the valve under fluid pressure—see FIGS. 9 and 11, the lips 3 may move closer to the longitudinal axis 5, or into alignment with the longitudinal axis 5, through the valve. In other embodiments, the lips 3 may extend not aligned with but at an angle to the valve longitudinal axis, even when the valve is not fitted in position to a pipe end or similar.

In the embodiment shown, the side walls 7a and 7b (see FIGS. 10 and 11) of the intermediate portion 7 are similar lengths. In another embodiment, one of side walls 7a or 7b may be longer than the opposite side wall. In another embodiment, one of side walls 7a or 7b of the intermediate portion 7 may taper at a shallower angle to the lips 3 than the other side wall.

Also, in the embodiment shown the valve comprises opposing enlarged side parts or ribs 8, at or part way along the opposite longitudinal sides 3c of the valve. These side parts or ribs 8 are enlarged parts of the joins or joining portions (seams) on the sides of the valve.

The side parts or ribs 8 are closer to the fluid entry end 2 of the valve than to the fluid exit end. In particular, the side parts or ribs 8 are located on the sides of the tapered intermediate portion 7 that joins the fluid entry end 2 to the flexible valve lips 3. These opposing enlarged side parts 8 are less flexible than the flexible valve lips 3. The side parts or ribs 8 tend to stiffen the valve or the sides of the valve in this area.

As shown, the enlarged parts 8 can be a widened area of the side joins or edges 3c forming a side web on each side.

Alternatively, the side joins or edges 3c could be locally thickened without being widened, and/or could be thickened inwardly slightly into the interior of the valve. The effect of these enlarged parts 8 of the joins or joining portions (seams) on the sides of the valve at this location, is to aid in biasing the flexible valve lips 3 towards each other to close the valve when not under fluid flow through the valve.

The enlarged parts 8 may also assist in ensuring that the valve lips 3 close together not only centrally but also fully at the outer sides of the valve near the parts 8, when the valve is closed. They may also assist in causing the flexible valve lips 3 to close towards one another particularly along a curved line (having an apex towards the valve outlet end), as indicated at 3f in FIG. 8.

In other embodiments, other structural features maybe provided to further encourage or increase the inducement of the valve lips being biased together into a closed condition. Examples include the strengthening or stiffening of at least one valve wall or a portion or portions of at least one valve wall—that is, a valve wall may be relatively greater thickness than an opposing valve wall, or one or a series of ribs extending substantially longitudinally along at least one valve wall may be provided, or other thickenings or strengthening's or rigidising elements or members may be formed as part of at least one of the valve walls. In this manner, the deformation of the valve from the first shape to the second shape or subsequent shape, may result in an even stronger tendency or force of bias of the valve lips toward each other.

Typically, lips 3 will separate or begin to separate to allow forward fluid flow through the valve at relatively light fluid pressure. The fluid pressure at which the lips 3 will separate or begin to separate to allow fluid flow through the valve, for any particular valve product may be ‘designed in’ by varying any one or more of:
the shape of the fluid entry end of the valve when not fitted to a circular pipe end or conduit or fitting, i.e., the degree of oval or elliptical shape of the fluid entry end of the valve and thus the extent to which the fluid entry end of the valve must be deformed away from this shape to a circular shape, thereby also deforming or changing the free shape of the tapered intermediate portion 7, and the shape of the flexible valve lips 3;
the free shape of the tapered intermediate portion 7 and the shape of the flexible valve lips 3 themselves, and the degree to which the lips 3 are separated when the valve is not fitted to a circular pipe end;
the size, shape, and particular location of the opposing enlarged side parts 8; and
the material from which the valve is formed,
the strengthening or stiffening of at least one valve wall or a portion or portions of at least one valve wall—that is, a valve wall may be relatively greater thickness than an opposing valve wall, or one or a series of ribs extending substantially longitudinally along at least one valve wall may be provided, or other thickenings or strengthening's or rigidising elements or members may be formed as part of at least one of the valve walls.

In the embodiment described above, the valve lips 3 are biased towards each other to contact each other and completely or almost completely block fluid back flow when the valve is closed.

When closed, the valve can block odour (i.e., as a non-return valve) from passing through from a reverse fluid flow direction, which may be useful when the valve is fitted, for example, in-line with an outlet from a sink or similar. The valve will block odour from within a drainage system, passing back up past the valve to the sink (and room or space in which the sink is situated).

In another embodiment, the valve lips 3 may not contact each other when the valve is closed. The valve may be designed to allow some forward fluid flow, for example, under no or relatively lower forward fluid pressure. In this condition (herein also “closed”) the valve may inhibit but does not stop fluid flow. Under higher forward fluid flow pressure, the flexible valve lips are forced apart to further open the valve and allow higher forward flow of fluid.

The valve lips 3 may be longer than they are wide. In other embodiments, for controlling flow from an oval or rectangular outlet or aperture which is wider than it is high, the valve lips may be wider than they are long. In such an embodiment, the entry end of the valve may also be wider than it is high, and when relaxed may define different first shapes, such as oval or rectangular or even circular entry aperture shapes.

The entry end of the valve, when relaxed, may define different first shapes, such as oval or rectangular or even circular entry aperture and can be deformed to a second shape or subsequent shape when the valve is fitted to the particular shape of the fluid outlet or aperture, can be deformed into an oval or rectangular shape of the fluid outlet or aperture. In such an embodiment the fluid entry end is still resiliently deformed from a first shape to a second shape.

The deformation of the fluid entry end increases bias of the flexible valve lips towards one another in the closed condition of the valve. Also, deformation of the entry end of the valve from the first shape to the second shape may increase bias of both of the flexible valve lips towards one another in the closed condition of the valve, or alternatively may have the effect of increasing bias of only one of the flexible valve lips, towards the other flexible valve lip. As noted previously in relation to the first shape and the subsequent second shape, each of these shapes may be of any shape.

The valve 1 may comprises of a plurality of lips 3 and does not need to be constrained to a pair of substantially opposing lips. Further description of such configurations is described elsewhere herein.

Advantageously, the lips 3 may be induced to be biased together with sufficient force that the valve can operate independently of being placed in a gravitationally fluid flow correct orientation—that is, the valve of the invention described herein could be used upside down and the valve lips would still move to their ‘closed’ position due to the sufficient inducement of force for closure of the lips, irrespective of the influence of gravity. In this manner, the valve can operate as a back-flow device.

In the embodiment described above, the entry end 2 of the valve comprises an integral flange 4, being of a first shape, such as an oval, or non-circular ring around the fluid entry aperture 2a to fit over a second shape conduit, such as a circular conduit.

Alternatively, the integral ring flange 4 of a first shape, may be a non-circular ring flange 4 and may be intended to fit into a second shaped conduit end, such as a circular conduit end. In another embodiment, the integral ring flange 4 (of a first shape, which may be non-circular) may be fitted and bonded in position into a second shaped conduit end, such as a circular shaped conduit end. In either case, the valve may be intended to be used with a clamp around the pipe end, which is tightened to hold the valve in position. In other embodiments, the valve may comprise a flange which enables the valve to be clamped in-line between two connected parts of a conduit.

In another embodiment, the valve may be an integrally manufactured part of a greater product such as a replacement heart valve insert product.

In other embodiments, the valve may be integrated into other products, whether medical devices or other devices which require a valve comprising of a one-way valve capability or a back-flow prevention capability, which provides for a self-closing valve configuration.

Further examples of non-return valve applications include but are not limited to the following: for a pump (e.g., a foot valve at the intake end of a suction line), a non-return valve in a sanitary water pipe system, within a process piping system, within a gas flow system, marine applications, drip lines (such as medical drip lines), or other medical apparatuses, such as masks or ventilators.

In the embodiment described above, the valve is one-piece but alternatively the valve may comprise separate parts attached together. For example, the flange may be formed separately and attached to the valve body. In the embodiment shown, the valve lips, entry end, and intermediate portion have a similar wall thickness but in other embodiments the wall thicknesses may be different. For example, the wall thickness of the entry may be greater than that of the valve lips.

In at least some embodiments, a fine particulate material may be incorporated in the silicone material, rubber, or synthetic polymer material, from which the valve is moulded.

The fine particular material may be used as an anti-block agent to roughen the contacting surfaces of the flexible lips 3 to prevent them from sticking together when the valve is closed. This may assist in causing the valve lips 3 to separate more readily to open the valve under light forwards fluid flows, for example.

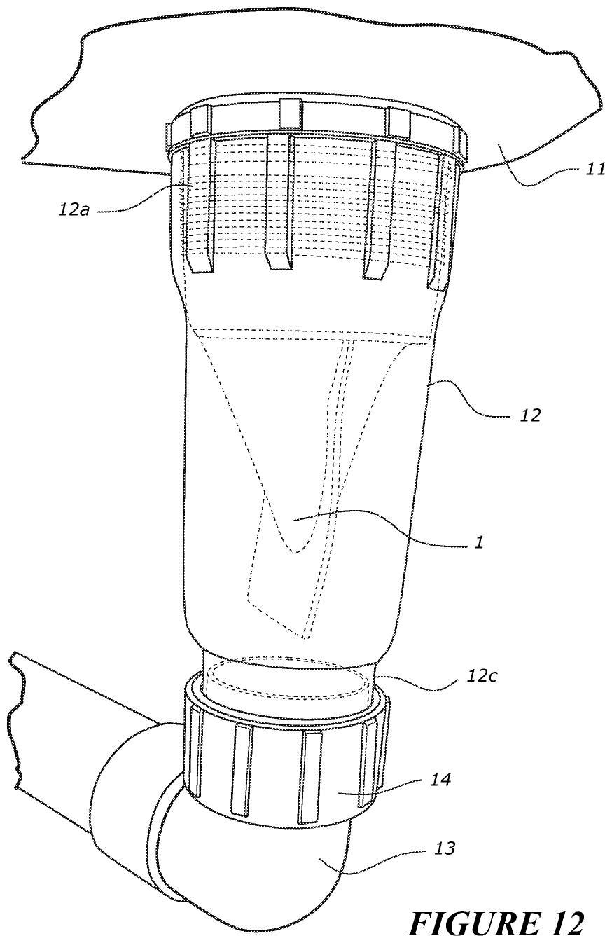

FIGS. 8 and 9 referred to previously, show the valve attached to a circular attachment or mounting ring 10. The valve and ring are a part of the waste valve fitting of FIGS. 12 to 15 described subsequently. In this embodiment, the valve component of FIGS. 1 to 6 is, during manufacturing of the completed valve or before sale, pre-fitted to the mounting ring 10. Doing so deforms the resiliently flexible valve component of FIGS. 1 to 6, from its relaxed state to the (closed or fitted) shape shown in FIG. 8.

FIG. 8 shows the flexible valve lips 3 are deformed, tipped, kicked, or moved to point to one side, and from out of alignment with the central longitudinal axis through the valve (axis 5 in FIG. 3).

As before, under forward flow fluid pressure through the valve the flexible valve lips 3 are forced apart as shown in FIG. 9, to open the valve and allow forward flow of fluid. The ring 10 may have a threaded exterior as shown, or interior, for mounting the valve in place, for example, attaching to plumbing pipes or waste outlets. The ring 10 may have a tapered interior for attaching to a pipe end in a taper fit.

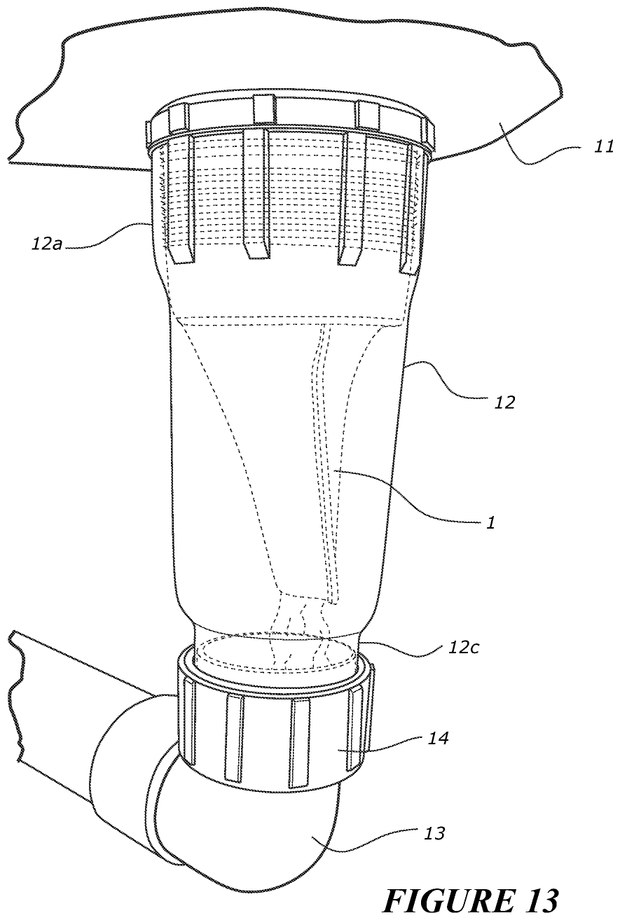

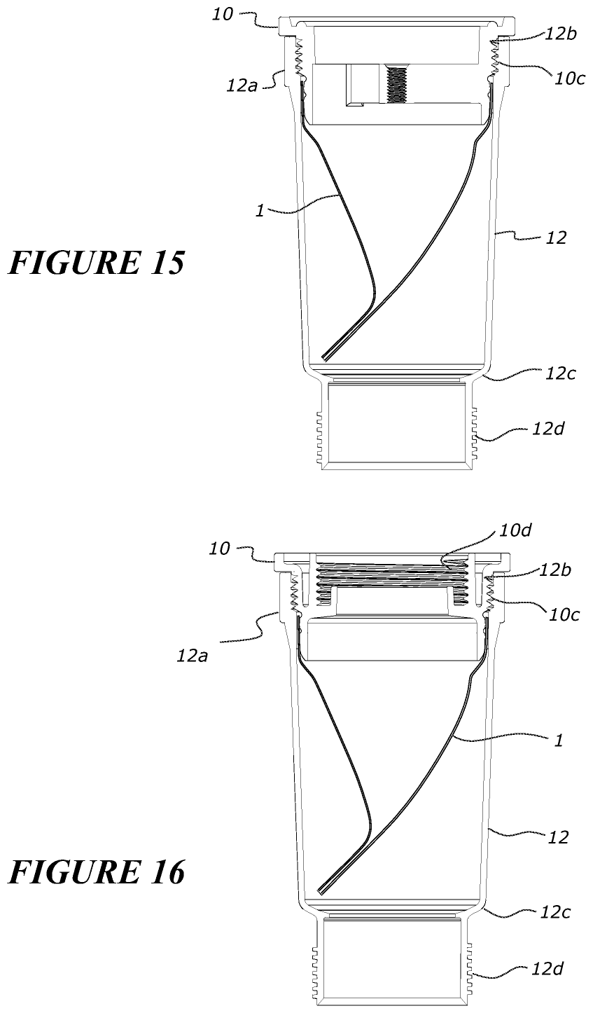

FIGS. 12 to 15 show an embodiment of a ‘straight-through’ waste valve fitting comprising the valve, for fitting the valve 1 to the outlet from a sink 11 as shown in FIGS. 12 and 13. The valve 1 is shown in phantom outline, closed in FIGS. 12 and 15, and open in FIG. 13, and is generally as described in relation to FIGS. 8 and 9.

The waste valve fitting comprises waste grate 15. When the fitting is installed, the waste grate 15 sits above the sink outlet aperture within the sink, with seal 16 between the waste grate 15 and sink. Threaded fastener 17 passes through a central aperture in the waste grate 15 and threads into the ring 10 at 18.

The waste valve fitting also comprises a housing 12 for fitting around and containing the valve 1 within the hollow interior of the housing. The coupling ring 10 also has a threaded exterior 10c. The inlet end 12a of the housing 12 has a threaded interior 12b by which the housing 12 screws onto the threaded exterior 10c of the coupling ring 10. To install the waste valve, the waste grate 15 and seal 16 are positioned on the topside of the sink outlet and the ring 10 carrying the valve 1 below and are clamped together by inserting and tightening the fastener 17. The housing 12 is then moved over the valve 1 and is screwed home onto the threaded exterior 10c of the ring 10 below the sink. The inlet end of the housing 12 optionally also may have gripping formations, as shown, so that it can easily be manually screwed into place.

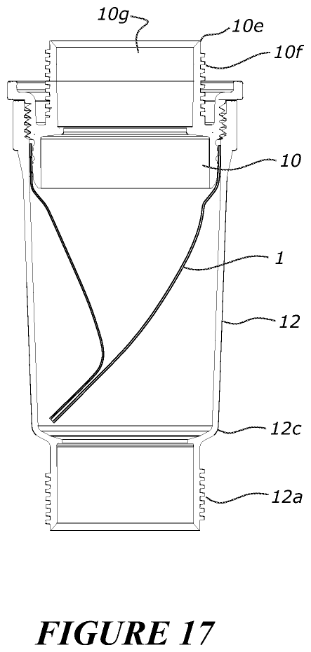

The outlet end 12c of the housing is adapted to couple to a downstream conduit 13 and deliver fluid flow from the valve when open, into the downstream conduit (see FIG. 13). For example, the outlet end 12c of the housing may have a threaded exterior 12d for receiving an internally threaded coupling ring 14 which fixes the end of conduit to the waste valve fitting, as shown (and see the later description in relation to FIG. 17). In another embodiment, instead of being threadedly coupled together, and thus separable, the valve 1 and housing 12 may be permanently fixed together.

FIG. 16 is an example of a cross-section view of a ‘straight-through’ type waste valve fitting similar to that of FIGS. 12 to 15 but designed for coupling to the threaded spigot below the sink, of a pre-existing waste fitting already installed to a sink outlet. In FIG. 16, similar reference numerals indicate that the waste valve fitting has similar parts to the waste valve fitting of FIGS. 12 to 15. The difference is that the fitting does not comprise waste grate 15, seal 16, fastener 17, or threaded aperture 18 in the ring 10. Instead, the interior of the ring 10 at its entry end comprises an internal thread 10d enabling it to be threaded onto the externally threaded spigot or tail of a pre-existing waste fitting already installed to a sink outlet. To install the waste valve, the ring 10 carrying the valve 1 is screwed onto the waste fitting beneath the sink, and then the housing 12 is screwed onto the threaded exterior 10c of the ring 10 as before. Alternatively, the valve arrangement can be a preassembled arrangement and then fitted (screwed) onto the waste thread.

FIG. 17 is a cross-section view similar to that of FIGS. 15 and 16, of a ‘straight-through’ valve fitting similar to that of FIGS. 12 to 15.

The embodiment shown in FIG. 17 is designed for coupling to a pipe end using an associated coupling nut and compression ring, instead of a sink outlet. Again, similar reference numerals in FIG. 17 indicate similar parts as in FIGS. 12 to 16. The difference is that the fitting does not comprise waste grate 15, seal 16, fastener 17, or threaded aperture 18 in the ring 10. Instead in the valve fitting of FIG. 17 the ring 10 comprises an extending spigot 10e with a threaded exterior 10f. The internal diameter of the spigot 10e matches a standard pipe outer diameter. The valve fitting includes a nut (like nut 14 in FIGS. 12 and 13) which can thread onto the exterior of the spigot 10e, and a compression ring. To couple the valve fitting to a pipe end the nut and compression ring are placed over the pipe end. The pipe end is then inserted fully into the interior 10g of the spigot 10e, and the nut is threaded onto the spigot, compressing the compression ring against the pipe exterior to form a seal. A pipe end can be coupled to the outlet end 12a of the fitting, and the outlet end of the fittings of FIGS. 12 to 16, in the same way.

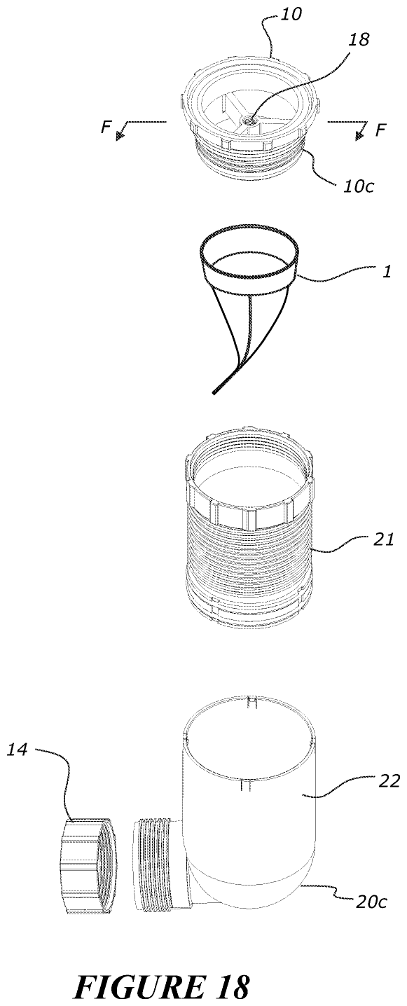

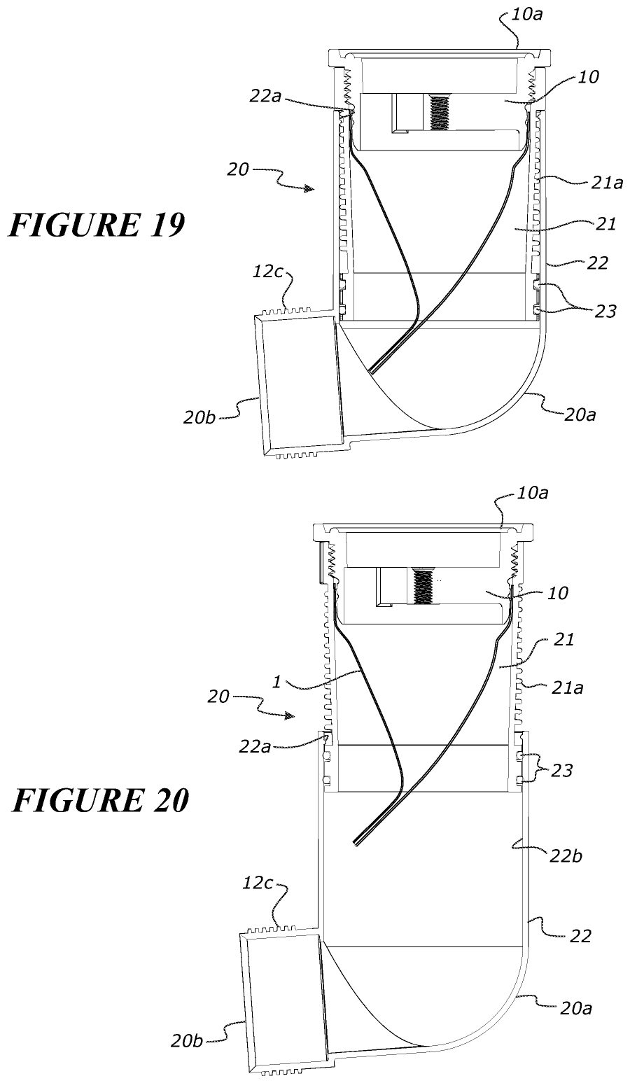

FIGS. 18 to 20 show an embodiment of an ‘extendable bend’ waste trap and valve fitting comprising a valve of the invention, for fitting to the outlet from a sink. The fitting is similar to that of FIGS. 12 to 15 except that the housing around the valve 1 (equivalent to housing 12 in FIGS. 12 to 16) is designed so that its length is adjustable. Although not shown, the fitting comprises a waste grate 15, seal 16, and fastener 17 which screws into threaded aperture 18 in the ring 10. In FIGS. 19 and 20 the housing is indicated at 20. Also, at its outlet end the housing has an integral bend 20a before threaded end 20b (with threads 12c as in other embodiments). In another embodiment, this may not be present so that the fitting is an extendable ‘straight through’ fitting instead of a bend fitting. The bend may be at any angle or can be adjustable. In an alternative embodiment, the waste grate 15, seal 16, fastener 17, and threaded aperture 18 in the ring 10 may be omitted.

In another embodiment, the ring 10 may be designed to couple to a pre-existing waste fitting already installed to a sink outlet as in the fitting of FIG. 16. Again, unless indicated otherwise similar reference numerals in FIGS. 18 to 20 indicate similar parts as in FIGS. 12 to 15.

In the extendable fitting of FIGS. 18 to 20, the housing 20 is formed in two parts 21 and 22. When the two parts 21 and 22 are threaded together it enables the length of the housing to be screw adjusted. In the embodiment shown, the housing is also enlarged relative to the diameter of the outlet from the housing/fitting, to form a bowl 20c at its lower end (see FIG. 18), so that the housing also comprises a plumbing trap.

The upper housing part 21 has an outside diameter and is externally threaded as indicated at 21a. The lower housing part 22 has a matching inside diameter and a (smaller) internally threaded part as indicated at 22a. A non-threaded lowermost end of the upper housing part 21 carries one or more O-ring seals 23 (or lip or other seal(s)) below threads 21a, which seal against a non-threaded part 22b of the interior of the lower housing part 22, and to provide a sealing surface over the range of movement between the two parts of the housing. The internally threaded part 22a of the interior of the lower housing part may be relatively short, and much shorter than the length of the threaded exterior 21a of the lower housing part. The threads on the interior of the lower housing part 22 are positioned close to the top of the housing part and may be simply angled ribs below the mouth of the lower housing part. The threads on the upper housing part engage with the angled ribs, instead of a discrete threaded portion.

In use, when the fitting is installed below a sink the length of the housing 20 can be screw adjusted to suit the position of the pipe to which the outlet of the fitting is to connect (as in FIGS. 12 and 13). FIG. 19 shows the fitting in its shortest configuration and FIG. 20 shows the fitting in its longest configuration.

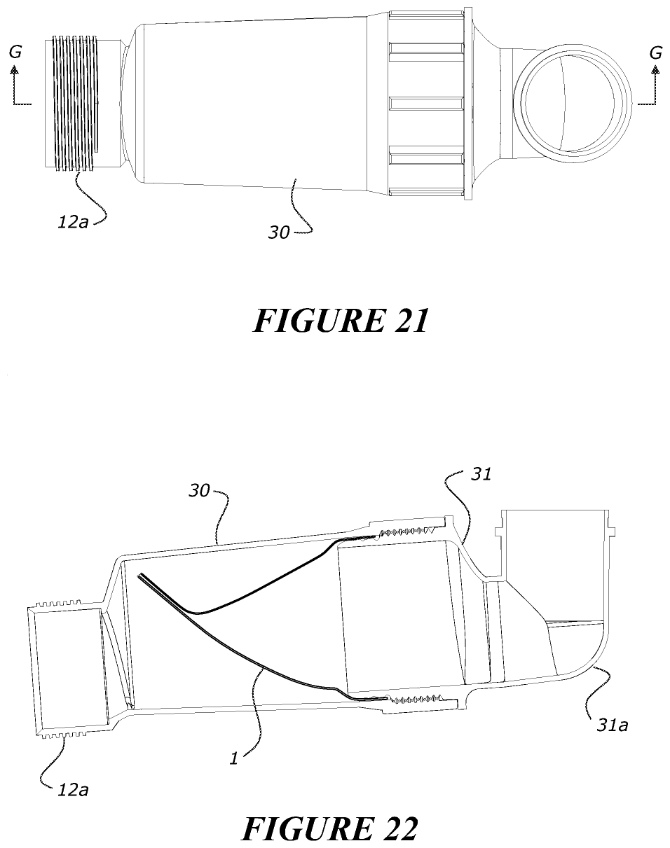

FIGS. 21 and 22 show an embodiment of a ‘horizontal’ valve fitting comprising a valve of the invention. The fitting can be used, for example, beneath a sink where there is little clearance, or at the end of a vertical pipe where the pipe connects to a horizontal pipe. The fitting comprises a housing generally similar to the housing 12 of the embodiment of FIGS. 12 to 17. A valve 1 carried by a cap part 31 which threads into the entry end of the housing and is approximately similar to the ring 10 of those embodiments, except that it comprises an inlet spigot 31a comprising a bend as shown. The bend can be at any angle. The bend may be at a right angle, as shown so that the fitting is a ‘horizontal’ valve fitting as described. The bend may be slightly more than degrees so that when installed, if coupled to a vertical pipe, the body of the fitting/housing 30 extends with a slight downward slope to horizontal to ensure correct flow through the fitting, although can be an adjustable angle to accommodate the trap fitting. The fitting while described as a ‘horizontal’ valve fitting, may be installed at any angle or orientation.

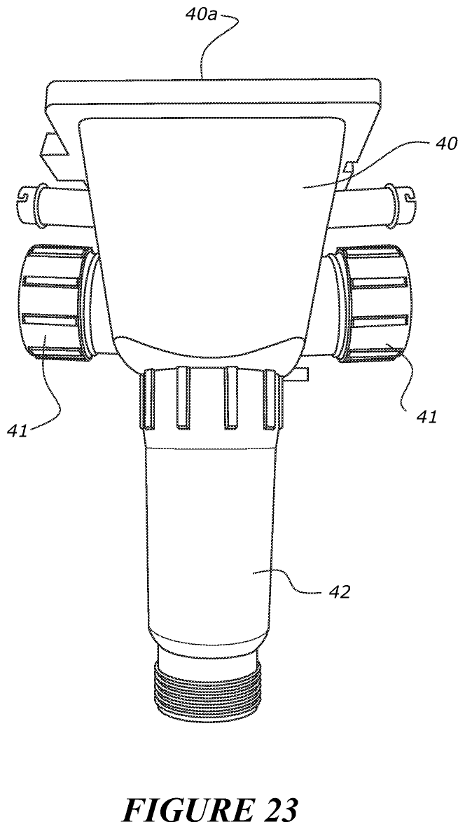

FIG. 23 shows an embodiment of a waste box 40 comprising at its outlet a valve fitting comprising a valve of the invention. The waste box may be of a type having a grate over its open top 40a. The waste box may also comprise one or more connection fittings 41 for coupling pipes which also deliver into the waste box. At its outlet the waste box comprises a valve fitting 42 similar to that of FIG. 16. The valve fitting 42 may thread onto a threaded outlet spigot of the waste box, to add a one-way valve to the waste box.

A fitting as described incorporating a valve of the invention, may be provided to prevent reverse fluid flow and/or to inhibit odours from downstream of the fitting, or a sink or waste box, from rising into the room or local environment.

In the embodiments of the valve described above, the entry end of the valve deforms from a non-circular, in particular an oval shape when in its relaxed state, to a circular shape when fitted to a pipe end. The deformation biases the valve lips towards one another. In other embodiments the entry end of the valve may, when in its relaxed state, have any other shape such as an approximately square or rectangular shape or another multi-sided shape, which is caused to deform to different but related shape when the valve is on a conduit having this related but different shape. For example, a four-sided parallelogram valve entry end when relaxed may deform to a square or rectangular shape when in place on a square or rectangular conduit.

In the embodiment described above, both of the flexible valve lips are flexible and resiliently biased towards one another in the closed condition of the valve. The flexible valve lips can flexibly move apart from one another to the open condition of the valve. Deformation of the fluid entry end of the valve increases bias of both valve lips towards one another.

In an alternative embodiment only one of the valve lips is flexible and resiliently biased towards the other in the closed condition of the valve. Only the valve lip which is flexible moves, between the closed and open conditions of the valve. The other valve lip is relatively inflexible, for example it may be relatively thicker and relatively inflexible compared to the flexible valve lip, and is static i.e., does not move or move significantly.

In a yet further embodiment, both of the valve lips are flexible, but one may be more flexible than the other and moves more than the other. The embodiment of a valve of the invention shown in the figures is as for a typical (wastewater) plumbing application. However, valves of the invention may be configured and used for any other plumbing application and any other non-return valve applications such as marine and medical applications for example.

A valve of the invention may be of any size such as a relatively large size when the valve comprises the bilge drainage valve at the stern of a boat or in a large-scale industrial application for example, or a relatively small size when the valve is part of a fluid flow path of diameter only a few millimetres in an item of medical equipment for example.

In a further embodiment, for example as illustrated by FIGS. 24-30, a valve 1 is shown. Such a valve 1 comprises of the same features as previously described, although note the valve lips 33 are arranged or positioned in a longitudinally off-set manner from a central longitudinal axis extending through the centre of the entry end 2 and entry end aperture 2a.

The off-set is indicated by the item L showing the indicative off-set. It will be appreciated the off-set L may be greater or smaller than that as shown, and the embodiment is illustrative only. A greater off-set L of the valve lips 3 may induce even greater stretch and/or deformation or a tension force to be imparted to one or both of the valve lips in this embodiment. It will be appreciated this concept can be applied to a valve configuration in which more than 2 valve lips may be provided.

In relation to FIGS. 24-30, it should be appreciated that optional additional features such as O-rings (for greater sealing with a fitting or conduit) or strengthening elements or members may be provided as required.

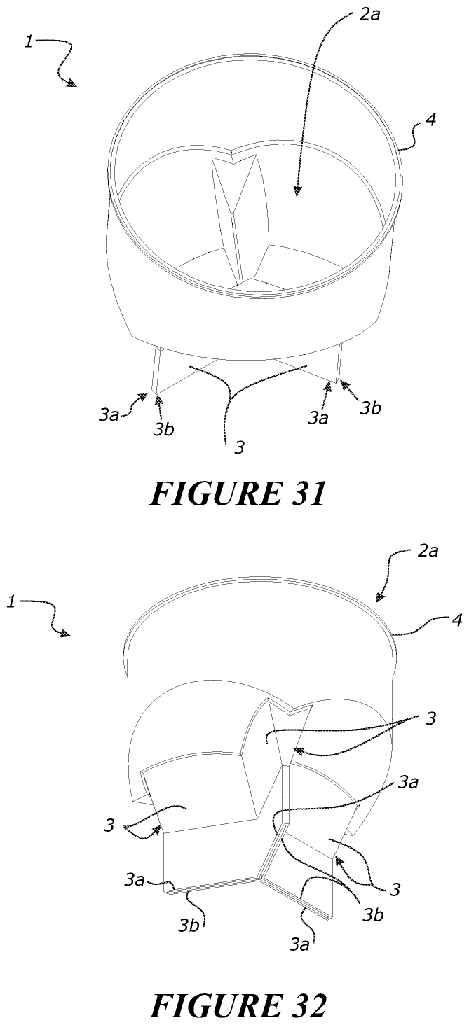

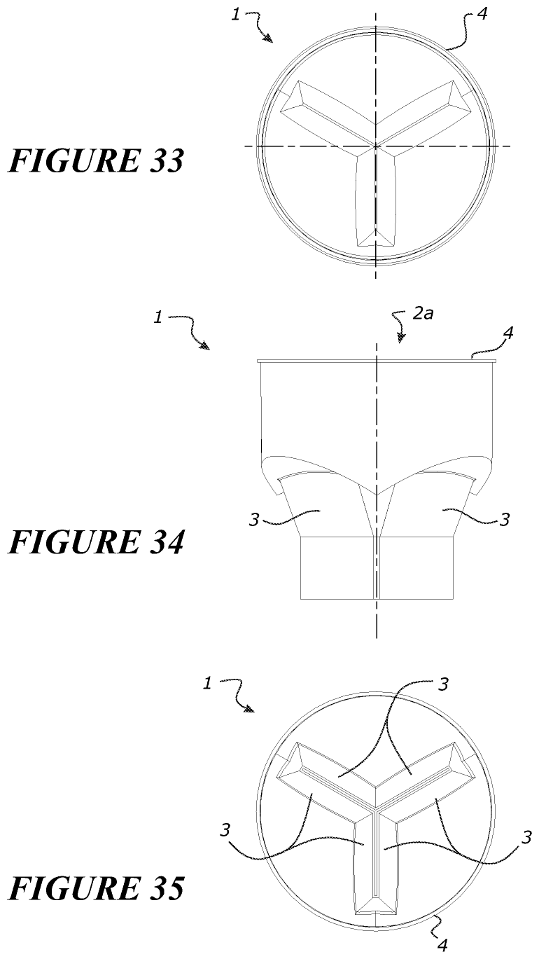

In a further embodiment, for example as illustrated by FIGS. 31-37a, is illustrated a configuration in which more than two valve lips may be used. In this configuration, three sets or pairs of valve lips are arranged equidistantly apart from each other. Each set or pair of valve lips are brought together to seal or contact each other and form a seal or closure to put the valve into a closed condition. Such a closed condition is achieved by the application of an induced bias or tension force to the valve, for example by stretching or deforming the fluid entry end of the valve. Such a stretch and/or deformation achieved by altering the first shape of the fluid entry end 2 of the valve 1 into a second shape. In this configuration, the first shape is shown as being substantially circular, while the second shape to which the fluid entry end 2 of the valve 1 is shown as being substantially cloverleaf in shape.

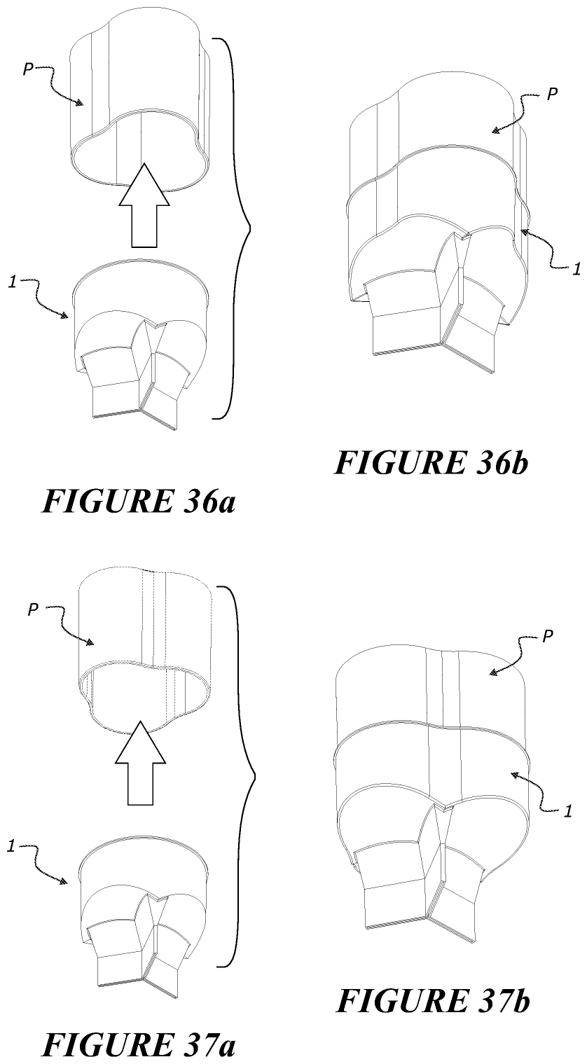

FIG. 36a shows a pre-assembly of the valve 1 to a conduit or fitting P. The fluid entry end of the valve 1 in the relaxed condition is substantially circular but is stretched and/or deformed to take up the second shape of the conduit or fitting P as indicated. FIG. 36b shows the completed assembly in which the second shape can been imparted to the fluid entry end of the valve 1. Note the ‘bulges’ of the conduit or fitting P in this example are showing as being substantially aligned with an intersection of each set or pair of valve lips 3a, 3b. In this manner, a localised maximum stretch or deformation is applied at the intersection of each set or pair of valve lips to induce a desired tension or bias for a closure force, or a force of biasing lips 3a, 3b together.

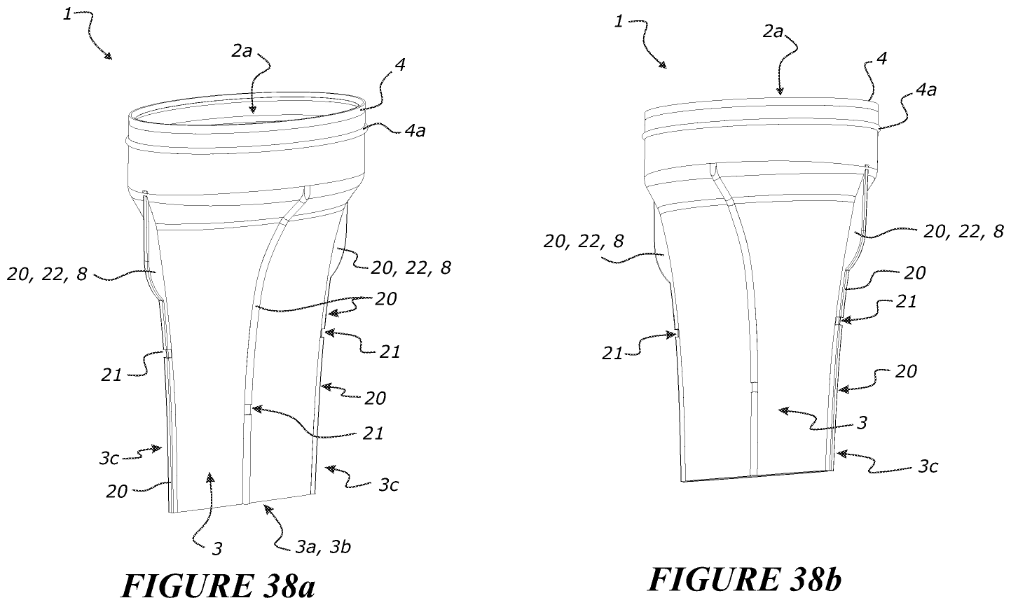

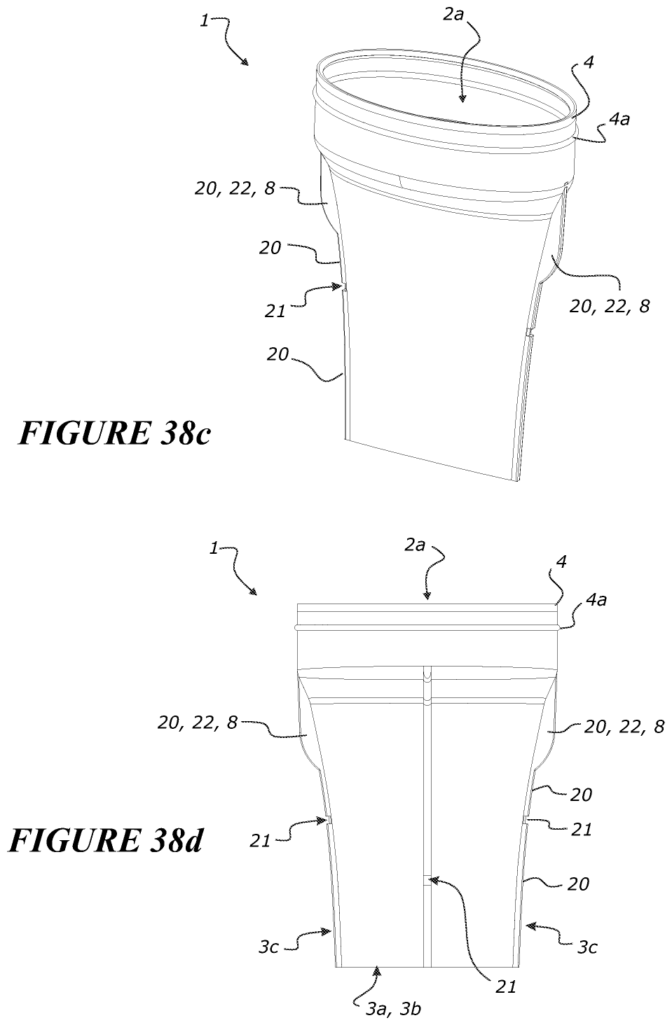

In an alternative, FIG. 37a also illustrates a similar arrangement to FIG. 36a, however as shown by FIG. 37b the ‘bulges’ of the conduit or fitting P in this example are showing as being substantially aligned between the intersection of each set or pair of valve lips 3a, 3b. In this manner, a localised maximum stretch or deformation is applied between the intersection of each set or pair of valve lips to induce a different desired tension or bias for a closure force, or a force of biasing lips 3a, 3b together.

In yet a further embodiment, as illustrated by FIGS. 38a-c, there is shown a valve 1. The valve 1 is similar to the embodiment illustrated and described with reference to FIGS. 1-23, but where the valve lips 3 comprise of strengthening elements or members. Strengthening elements or members in these figures are shown as ribs indicated as item 20. Note the ribs can take various forms and may comprise of discontinuities (or gaps) such as in those regions indicated as item 21. The strengthening elements or members can be provided on all valve lips, or a selection of valve lips, or one of a pair of valve lips. In FIGS. 38a-c, an embodiment is shown in which strengthening elements or members are provided along seam portions joining a pair of substantially opposing valve lips 3, with a flared portion or segment provided as a shoulder 22 (which also acts as a side part 8 as previously described) substantially adjacent a flange or entry end of the valve. Note as shown in FIG. 38c, that in this embodiment one of the valve lips 3 does not have a rib 20 which extends centrally down the face of the valve lip 3 (FIGS. 38a, 38b and 38d show a valve lip 3 with a rib 20 extending centrally down the valve lip 3).

The foregoing description of the invention includes preferred forms thereof. Modifications may be made thereto without departing from the scope of the invention as defined in the accompanying claims.

1. A valve comprising:
valve lips, at least one of which is flexible and resiliently biased towards another valve lip in a closed condition of the valve in which fluid flow through the valve is inhibited, and is flexibly moveable apart to an open condition of the valve in which fluid flow through the valve is enabled,
and which comprises a resiliently deformable opposite fluid entry end of the valve which is resiliently deformable from a first shape to a second shape to fit the valve to a conduit end,
wherein deformation of the fluid entry end of the valve to said second shape increases bias of the at least one flexible valve lip towards another valve lip for contact of respective valve lips in the closed condition of the valve.

2. The valve of claim 1, further comprising opposite or substantially opposing valve lips at least one of which is resiliently biased towards one another in the closed condition of the valve, and the at least one flexible lip is moveable apart from one another lip to the open condition of the valve in which fluid flow through the valve is enabled, and wherein deformation of the fluid entry end of the valve to said second shape increases bias of the at least one flexible valve lip(s) towards another lip or contact of the valve lips in the closed condition of the valve.

3. The valve of claim 1 or 2, wherein there is a pair of substantially opposing flexible valve lips.

4. The valve of claim 1 or 2, wherein there are three or more flexible valve lips configured to be biased towards each other for contact of these respective valve lips to bring the valve into a closed condition, and wherein said three or more flexible valve lips a moveable apart from each other into an open condition of the valve.

5. The valve of any one of claims 1 to 4, wherein the first shape is different to the second shape.

6. The valve of any one of claims 1 to 5, wherein said first shape is non-circular and said second shape is circular.

7. The valve of any one of claims 1 to 6, wherein the first shape is substantially oval and wherein the second shape is the shape of a conduit or outlet or spigot end of a fitting upon which the fluid entry end of the valve is to be fitted.

8. The valve of any one of claims 1 to 7, wherein at least when the fluid entry end of the valve is deformed to said second shape, and the valve is in a closed condition, the flexible valve lips extend at an angle, such as an off-set angle, relative to a longitudinal central axis through the valve.

9. The valve of any one of claims 1 to 8, wherein the flexible valve lips are relatively thin-walled, joined at longitudinal edges, and are longer in a fluid flow direction length of the valve than they are wide across said length of the valve, and wherein deformation of the fluid entry end of the valve to define the second shape of the fluid entry aperture increases bias of the flexible valve lips towards one another across a width of the flexible valve lips and along at least part of a length of the flexible valve lips, in the closed condition of the valve.

10. The valve of any one of claims 1 to 9, further comprising a tapered intermediate portion between the fluid entry end and the flexible valve lips.

11. The valve of claim 10, wherein said intermediate portion comprises an internal cross-section area which reduces between the fluid entry end and the flexible valve lips.

12. The valve of any one of claims 1 to 11, further comprising opposing enlarged side parts, at or part way along opposite longitudinal sides of the valve.

13. The valve of claim 12, wherein the opposing enlarged side parts are less flexible than the flexible valve lips.

14. The valve of claim 12 or 13, wherein the opposing enlarged side parts are relatively closer to the fluid entry end of the valve than to a fluid exit end of the valve.

15. The valve of any one of claims 12 to 14, wherein the opposing enlarged side parts are at opposite joins or joining portions on opposite longitudinal sides of the valve.

16. The valve of claim 15, wherein the opposing enlarged side parts are enlarged (seam) parts of the opposite joins or joining portions on opposite longitudinal sides of the valve.

17. The valve of any one of claims 1 to 16, further comprising a tapered intermediate portion between the fluid entry end and the flexible valve lips and wherein opposing enlarged side parts are at opposite sides of the tapered intermediate portion.

18. The valve of any one of claims 1 to 17, wherein the entry end of the valve comprises a flange extending around the fluid entry aperture to fit over or into an end of a conduit, and the fluid entry end of the valve deformed from the first shape to the second shape to fit over or into the end of the conduit and to define the fluid entry aperture.

19. The valve of any one of claims 1 to 18, wherein the entry end of the valve comprises a flange around the fluid entry aperture to fit over or into a circular end of a conduit when the fluid entry end of the valve is deformed to define a circular fluid entry aperture.

20. The valve of any one of claims 1 to 19, wherein the valve is formed as a one-piece or unitary body.

21. The valve of any one of claims 1 to 20, further comprising, at the fluid entry end, a non-integral rigid non-circular or circular ring.

22. The valve of any one of claims 1 to 21, further comprising a housing about the valve, the housing comprising of an outlet end adapted to couple to a downstream conduit and deliver fluid flow from the valve when in the open condition into the downstream conduit.

23. The valve of claim 22, wherein the valve comprises at the fluid entry end a coupling ring, and an inlet end of the housing is adapted to couple to said coupling ring of the valve.

24. The valve of claim 23, wherein the valve coupling ring comprises of a threaded interior and a threaded exterior, and the inlet end of the housing has a threaded interior for coupling to the threaded exterior of the coupling ring.

25. The valve of any one of claims 1 to 24, wherein at least one of the valve lips comprises of one or more strengthening elements or members.

26. The valve of claim 25, wherein the one or more strengthening elements or members comprises one or more of: a relatively thicker wall or relatively thicker wall portion(s) than another valve lip or a substantially opposing valve lip(s), one or more ribs extending about or along at least one valve lip or each valve lip or both of a pair of opposing valve lips, one or more other surface features which may be used to characterise or impart a different stretch or deformation characteristic to at least one valve lip or each valve lip or both of a pair of opposing valve lips.

27. The valve of claim 26, wherein the one or more ribs extend in a longitudinal length direction of at least one valve lip or each valve lip, or each of a pair of opposing valve lips, or extend radially about at least one valve lip or each valve lip or each of a pair of opposing valve lips, or may extend in plurality of directions along at least one valve lip or each valve lip or each of a pair of opposing valve lips.

28. The valve of any one of claims 1 to 27, wherein said valve comprises of a plurality of valve lips brought into contact with each other by an induced force or tension applied to one or more or all of said plurality of valve lips with a positive contact or sealing force with each other, said positive contact or sealing force adjustable depending upon a deformation of the fluid entry end of the valve.

29. The valve of any one of claims 1 to 28, wherein in the open condition with the valve lips apart, a fluid flow through the valve is enabled to flow in a direction from the fluid entry end of the valve (being the fluid received into the fluid entry end of the valve) to a fluid exit end from the valve via the valve lips.

30. The valve of any one of claims 1 to 29, wherein the valve in the closed condition is a non-return valve.

31. The valve as claimed in any one of claims 1 to 30, where the valve lips provide for a self-closure and a sealing force of the valve lips, independent of a downstream backpressure upon the valve lips.

32. A valve fitting comprising the valve according to any one of claims 1 to 31.

33. A waste valve plumbing fitting comprising the valve according to any one of claims 1 to 31.

34. A waste valve and trap plumbing fitting comprising the valve according to any one of claims 1 to 31.

35. The fitting according to any one of claims 32 to 34, comprising:
a housing about the valve comprising a fluid flow inlet to the housing
and a fluid flow outlet from the housing.

36. The fitting according to claim 35, wherein the housing comprises two parts which are adjustable relative to one another to enable length adjustment of the housing.

37. The fitting of claim 35 or 36, wherein the valve is carried by a part which inserts into the fluid flow inlet to the housing.
